(19) United States
(12) Patent Application Publication
(10) Pub. No.: US 2020/0380365 A1
(43) Pub. Date: Dec. 3, 2020

(54) LEARNING APPARATUS, METHOD, AND PROGRAM

(71) Applicant: FUJIFILM Corporation, Tokyo (JP)

(72) Inventor: Takatoshi KARINO, Tokyo (JP)

(73) Assignee: FUJIFILM Corporation, Tokyo (JP)

(21) Appl. No.: 16/999,081

(22) Filed: Aug. 21, 2020

Related U.S. Application Data
(63) Continuation of application No. PCT/JP2019/005533, filed on Feb. 15, 2019.

(30) Foreign Application Priority Data
Feb. 28, 2018 (JP) 2018-035356

(51) Int. Cl. G06N 3/08; G06N 3/04; G06F 17/18

(52) U.S. Cl. CPC G06N 3/08; G06F 17/18; G06N 3/0472

(57) ABSTRACT

There is provided a learning apparatus, a method, and a program that can prevent overlearning and improve generalization performance while suppressing deterioration of convergence performance in learning. A learning apparatus includes a learning unit that performs learning of a neural network composed of a plurality of layers and including a plurality of skip connections in which an output from a first layer to a second layer which is a layer next to the first layer is branched to skip the second layer and is connected to an input of a third layer located downstream of the second layer, a connection invalidating unit that invalidates at least one of the skip connections in a case where the learning is performed, and a learning control unit that changes the skip connection to be invalidated by the connection invalidating unit and causes the learning unit to perform the learning.

### CROSS-REFERENCE TO RELATED APPLICATIONS

This application is a Continuation of PCT International Application No. PCT/JP2019/005533 filed on Feb. 15, 2019, which claims priority under 35 U.S.C § 119(a) to Japanese Patent Application No. 2018-035356 filed on Feb. 28, 2018.

### BACKGROUND OF THE INVENTION

### 1. Field of the Invention

The present invention relates to a learning apparatus, a method, and a program, and particularly to a learning apparatus, a method, and a program using deep learning.

### 2. Description of the Related Art

In recent years, it has been proposed to use deep learning, in particular, a neural network (NN) or a convolutional neural network (CNN) in recognition of an object in an image. In deep learning, it is considered that the deeper the layer, the higher the recognition accuracy.

In the learning in the neural network, an error backward propagation method is used. In the error backward propagation method, the error between the output of each layer and the correct answer backward propagates from the output layer side to the input layer side, and a gradient is calculated from the error, thereby updating the weight in each layer. In deep learning, in a case where the layer is simply made deeper, it becomes more difficult for an error to be transmitted to the input layer side as the layer becomes deeper. Therefore, the gradient becomes 0 or a small value close to 0, and the gradient disappearance problem that the weight in each layer is not updated occurs, and the performance of the neural network deteriorates.

In the neural network, a model has been proposed that has a skip connection in which the output from a first layer to a next second layer is branched and the second layer is shortcut, and the output from the first layer is connected to a third layer located downstream of the second layer (He, K. et al., “Deep Residual Learning for Image Recognition”, 2016, Proceedings of IEEE conference on Computer Vision and Pattern Recognition (CVPR) and Huang, G. et al., “Densely connected convolutional networks”, [online], 2016, arXiv, [Searched on Feb. 26, 2018], Internet <URL: https://arxiv.org/abs/1608.06993>).

He, K. et al., “Deep Residual Learning for Image Recognition”, 2016, Proceedings of IEEE conference on Computer Vision and Pattern Recognition (CVPR) is a document relating to a residual network (ResNet). In the ResNet, residual is learned by adding the output of the previous layer to the downstream side using the skip connection.

Huang, G. et al., “Densely connected convolutional networks”, [online], 2016, arXiv, [Searched on Feb. 26, 2018], Internet <URL: https://arxiv.org/abs/1608.06993> is a document relating to a dense convolutional network (DenseNet). In DenseNet, the output of the previous layer is connected to the downstream side using the skip connection.

According to He, K. et al., “Deep Residual Learning for Image Recognition”, 2016, Proceedings of IEEE conference on Computer Vision and Pattern Recognition (CVPR) and Huang, G. et al., “Densely connected convolutional networks”, [online], 2016, arXiv, [Searched on Feb. 26, 2018], Internet <URL: https://arxiv.org/abs/1608.06993>, it is considered that the gradient disappearance problem due to a deeper layer can be improved by connecting the output of the previous layer to the downstream side using the skip connection.

In a neural network, in a case where the layer becomes deep and the number of parameters increases, and the structure of the neural network becomes complicated, although a correct answer can be obtained for learned data, it may be an overlearning state that cannot be applied to unknown data other than the learned data. The inventions disclosed in He, K. et al., “Deep Residual Learning for Image Recognition”, 2016, Proceedings of IEEE conference on Computer Vision and Pattern Recognition (CVPR) and Huang, G. et al., “Densely connected convolutional networks”, [online], 2016, arXiv, [Searched on Feb. 26, 2018], Internet <URL: https://arxiv.org/abs/1608.06993> cannot cope with the problem of deterioration of generalization performance due to overlearning.

To solve the problem related to overlearning, U.S. Pat. No. 9,406,017B and Huang, G. et al., “Deep Networks with Stochastic Depth”, 2016, European Conference on Computer Vision (ECCV), Springer International Publishing disclose techniques for improving generalization performance in the neural network.

U.S. Pat. No. 9,406,017B discloses a technique called DROPOUT. In U.S. Pat. No. 9,406,017B, in a case where learning is performed, ensemble learning for improving generalization performance is performed by randomly (probabilistically) selecting and invalidating a feature detector. The feature detector inUS9406017B corresponds to a node in the neural network and a filter in the convolutional neural network.

In Huang, G. et al., “Deep Networks with Stochastic Depth”, 2016, European Conference on Computer Vision (ECCV), Springer International Publishing, in a case where learning is performed, a connection from each layer in a Residual Block (ResBlock) of ResNet to the next layer is randomly removed, and a skip connection is maintained.

### SUMMARY OF THE INVENTION

In U.S. Pat. No. 9,406,017B and Huang, G. et al., “Deep Networks with Stochastic Depth”, 2016, European Conference on Computer Vision (ECCV), Springer International Publishing, a main stream, which is a connection from each layer to the next layer, instead of a skip connection, is invalidated or removed. In a case where the ensemble learning is performed, in a case where the connection of the main stream is invalidated, the learning is not performed in the layer connecting to the invalidated main stream, so that there is a problem that the convergence performance deteriorates.

The present invention has been made in view of such circumstances, and an object of the invention is to provide a learning apparatus, a method, and a program that can prevent overlearning and improve generalization performance while suppressing deterioration of convergence performance in learning.

In order to solve the above problem, a learning apparatus according to a first aspect of the invention comprises a learning unit that performs learning of a neural network composed of a plurality of layers and including a plurality of skip connections in which an output from a first layer to a second layer which is a layer next to the first layer is branched to skip the second layer and is connected to an input of a third layer located downstream of the second layer, a connection invalidating unit that invalidates at least one of the skip connections in a case where the learning is performed, and a learning control unit that changes the skip connection to be invalidated by the connection invalidating unit and causes the learning unit to perform the learning.

According to a second aspect of the invention, in the learning apparatus of the first aspect, in the neural network, the skip connection may be provided in an intermediate layer.

According to a third aspect of the invention, in the learning apparatus of the first or second aspect, the connection invalidating unit may randomly select the skip connection to be invalidated.

According to a fourth aspect of the invention, in the learning apparatus of any one of the first to third aspects, the connection invalidating unit may select the skip connection to be invalidated based on a preset probability.

According to a fifth aspect of the invention, in the learning apparatus of any one of the first to fourth aspects, the connection invalidating unit may set an output that forward propagates through the skip connection to zero to invalidate the skip connection.

According to a sixth aspect of the invention, in the learning apparatus of any one of the first to fifth aspects, the connection invalidating unit may block backward propagation through the skip connection to invalidate the skip connection.

A learning method according to a seventh aspect of the invention comprises a connection invalidating step of invalidating, in a case where learning is performed by a learning unit that performs learning of a neural network composed of a plurality of layers and including a plurality of skip connections in which an output from a first layer to a second layer which is a layer next to the first layer is branched to skip the second layer and is connected to an input of a third layer located downstream of the second layer, at least one of the skip connections, and a learning control step of changing the skip connection to be invalidated in the connection invalidating step and causing the learning unit to perform the learning.

A learning program according to an eighth aspect of the invention causes a computer to realize a function of performing learning of a neural network composed of a plurality of layers and including a plurality of skip connections in which an output from a first layer to a second layer which is a layer next to the first layer is branched to skip the second layer and is connected to an input of a third layer located downstream of the second layer, a function of invalidating at least one of the skip connections in a case where the learning is performed, and a function of changing the skip connection to be invalidated and performing the learning. A learning apparatus according to another aspect of the invention is a learning apparatus including a processor that performs learning of a neural network composed of a plurality of layers and including a plurality of skip connections in which an output from a first layer to a second layer which is a layer next to the first layer is branched to skips the second layer and is connected to an input of a third layer located downstream of the second layer, invalidates at least one of the skip connections in a case where the learning is performed, and changes the skip connection to be invalidated to perform the learning.

According to the invention, it is possible to repeatedly perform learning using neural networks having different ways of layer connection by changing a skip connection to be invalidated and performing learning. Therefore, ensemble learning can be realized, so that the generalization performance of the neural network can be improved. Furthermore, according to the invention, since only the skip connection is set as the invalidation target, the connection of the main streams is maintained, so that it is possible to suppress deterioration of the learning convergence performance.

### BRIEF DESCRIPTION OF THE DRAWINGS

FIG. 1 is a block diagram showing a learning apparatus according to an embodiment of the invention.

FIG. 2 is a diagram for explaining a skip connection.

FIG. 3 is a block diagram showing a configuration example of a neural network in a discriminator according to the embodiment of the invention.

FIG. 4 is a flowchart showing a learning method according to the embodiment of the invention.

FIG. 5 is a block diagram showing an image recognition system comprising the learning apparatus according to the embodiment of the invention.

FIG. 6 is a block diagram showing a configuration example of a neural network in a discriminator used in Example 1.

FIG. 7 is a block diagram showing a configuration example of a neural network in a discriminator used in Example 2.

### DESCRIPTION OF THE PREFERRED EMBODIMENTS

Hereinafter, embodiments of a learning apparatus, a method, and a program according to the invention will be described with reference to the drawings.

[Learning Apparatus]

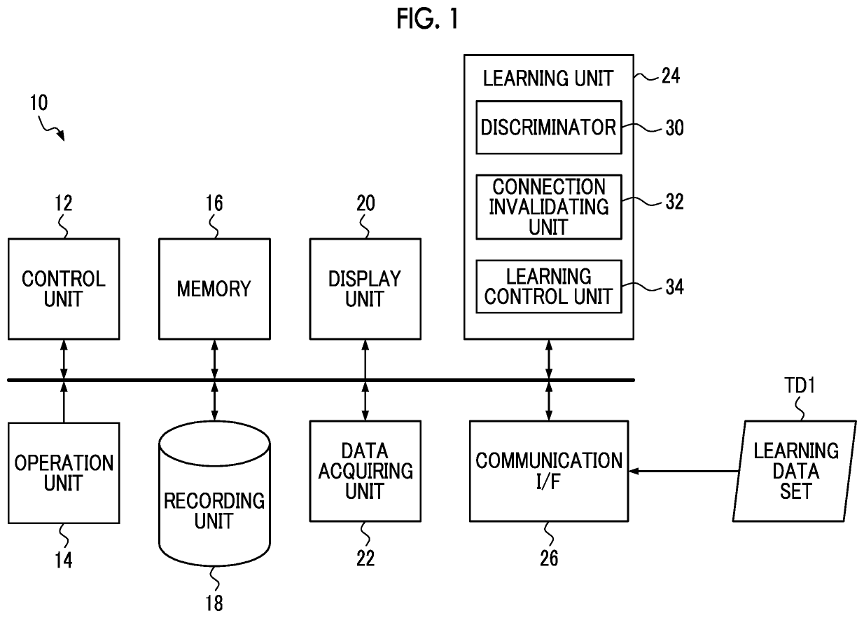

FIG. 1 is a block diagram showing a learning apparatus according to an embodiment of the invention.

As shown in FIG. 1, a learning apparatus 10 according to the embodiment comprises a control unit 12, an operation unit 14, a memory 16, a recording unit 18, a display unit 20, a data acquiring unit 22, a learning unit 24, and a communication interface (a communication I/F) 26.

The control unit 12 includes a central processing unit (CPU) that controls operations of units of the learning apparatus 10. The control unit 12 may comprise a graphics processing unit (GPU) in addition to or instead of the CPU. The control unit 12 can transmit and receive control signals and data to and from each unit of the learning apparatus 10 via a bus. The control unit 12 receives an operation input from an operator via the operation unit 14, transmits the control signals according to the operation input to each unit of the learning apparatus 10 via the bus, and controls operations of the units.

The operation unit 14 is an input device that receives the operation input from the operator, and includes a keyboard for inputting characters, a pointing device (for example, mouse or trackball) for operating a pointer and icons displayed in the display unit 20. As the operation unit 14, a touch panel may be provided on the surface of the display unit 20 instead of the keyboard and the pointing device, or in addition to the keyboard and the pointing device.

The memory 16 includes a random access memory (RAM) used as a work area for various operations performed by the control unit 12 and the like, and a video random access memory (VRAM) used as an area for temporarily storing image data output to the display unit 20.

The recording unit 18 is a storage device that stores a control program used by the control unit 12 and data received by the learning apparatus 10. As the recording unit 18, for example, a device including a magnetic disk such as a hard disk drive (HDD) or a device including a flash memory such as an embedded multi media card (eMMC) or a solid state drive (SSD) can be used.

The display unit 20 is a device for displaying an image. As the display unit 20, for example, a liquid crystal monitor can be used.

The communication I/F 26 is means for communicating with other devices via a network, and performs conversion processing of data to be transmitted and received according to a communication method. As the method of transmitting and receiving data between the learning apparatus 10 and other devices, wired communication or wireless communication (for example, a local area network (LAN), a wide area network (WAN), or the Internet connection) can be used.

The data acquiring unit 22 acquires a learning data set TD1 via the communication I/F 26.

The learning unit 24 causes a discriminator 30 to perform learning using the learning data set TD1 acquired by the data acquiring unit 22. In a case where the discriminator 30 is an image recognition engine for recognizing a subject in the image, as the learning data set TD1, for example, a supervised learning data set in which the image is input, and a name, a type, or a property of the subject appearing in the image is output (correct answer data) can be used.

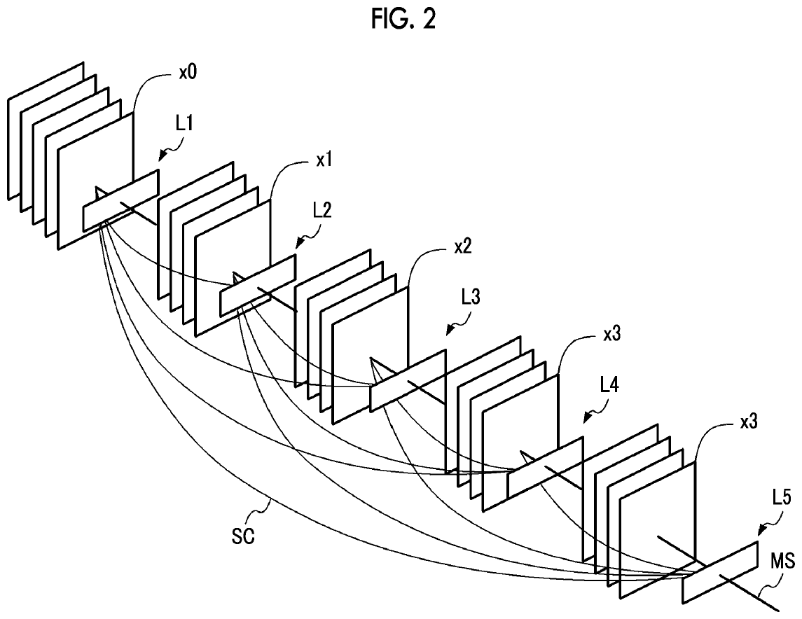

The discriminator 30 is configured by, for example, using a convolutional neural network, and the convolutional neural network includes skip connections. FIG. 2 is a diagram for explaining a skip connection.

In the neural network shown in FIG. 2, layers L1 to L5 are shown in order from the upstream side to the downstream side. Inputs to the layers L1 to L5 are x0 to x4.

A skip connection SC refers to connection in which an output from a first layer to a second layer which is a layer next to the first layer is branched to skip the second layer and is connected to an input of a third layer located downstream of the second layer, that is, a connection to one or more layers ahead.

In the following description, a connection MS among the connections between the layers other than the skip connection is referred to as a main stream.

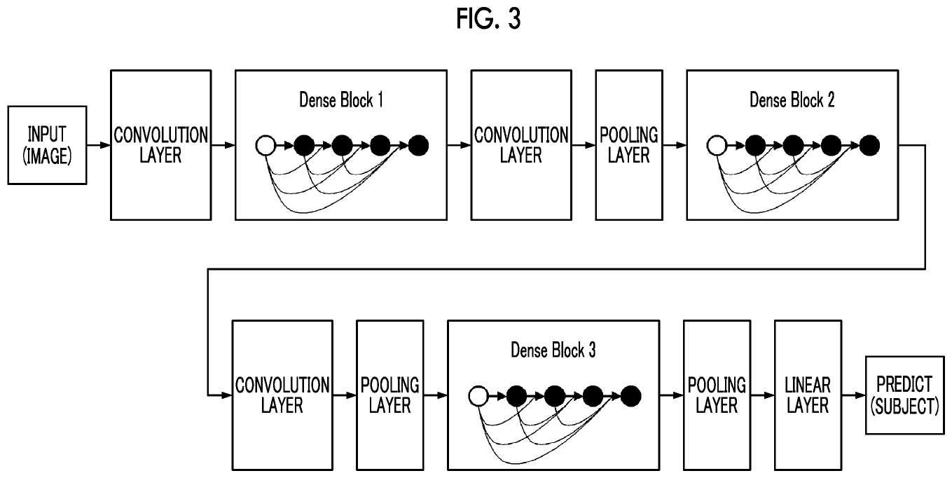

FIG. 3 is a block diagram showing a configuration example of a neural network in a discriminator according to the embodiment of the invention.

FIG. 3 shows an example in which the invention is applied to a dense convolutional network (DenseNet). DenseNet has a skip connection, and performs connection of data at a connection point.

In FIG. 3, the discriminator 30 is an image recognition engine that inputs an image, recognizes what the subject is in the image, and outputs the result as prediction.

In the example shown in FIG. 3, a set of one white circle and four black circles is defined as a dense block. FIG. 3 shows three dense blocks.

In FIG. 3, the white circle indicates an input layer of the dense block, and the black circles indicate a layer performing a series of processing of batch normalization rectified linear unit (ReLU) convolution. In the following description, the black circle is referred to as a dense unit.

The batch normalization is processing for preventing the gradient disappearance, and is processing of normalizing the value of each element of the batch in the batch learning using the average and the variance in the batch. The batch normalization is described in, for example, Ioffe, S. et al., “Batch Normalization: Accelerating Deep Network Training by Reducing Internal Covariate Shift”, 2015, International Conference on Machine Learning (ICML).

The ReLU has a role of determining how the sum of the input signals is activated, and arranges values to be passed to the next layer. The ReLU is described in Glorot, X. et al., “Deep Sparse Rectifier Neural Networks”, 2011, Proceedings of the Fourteenth International Conference on Artificial Intelligence and Statistics (AISTATS).

Each arrow in FIG. 3 represents a connection between the layers. Curved arrows indicate skip connections. As shown in FIG. 3, in the embodiment, the skip connection is provided in an intermediate layer other than an input layer and an output layer. In the embodiment, the skip connection extending from each layer (the white circles and the black circles) is configured to be connected to all of the main stream connections between the black circles, but the embodiment is not limited thereto. For example, there may be a main stream to which skip connections are not connected.

In a case where there are a plurality of arrows toward the dense unit (in a case where a skip connection is input), the input from the main stream and the data input from the skip connection are connected. In the embodiment, as a method of connecting data, for example, an input from the main stream and an input from the skip connection may be connected by operation (for example, addition). In the deep learning framework tensor flow (TensorFlow (registered trademark)), a method may be adopted in which numerical data arranged in the order of channel, height, and width are connected to the end of the numerical data arranged in the same order. The order and method of connecting data are not limited to the above. The order and method of connecting data may be any method as long as it is fixed at the time of learning and at the time of inference.

[Learning Method]

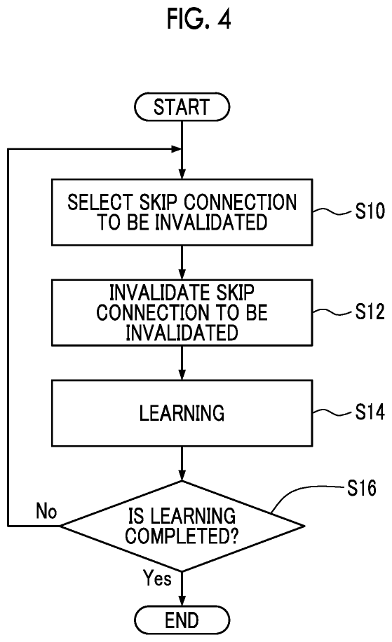

Hereinafter, the operation in a case of the neural network learning will be described with reference to FIG. 4. The following operation is performed for each batch. FIG. 4 is a flowchart showing a learning method according to the embodiment of the invention.

First, the connection invalidating unit 32 of the learning unit 24 selects a skip connection to be invalidated (step S10), and invalidates the selected skip connection (step S12). Steps S10 and S12 are referred to as a connection invalidation step.

Next, the learning control unit 34 performs learning of the neural network in the discriminator 30 with the invalidated skip connection (step S14). Then, the learning control unit 34 changes the skip connection to be invalidated, and causes the discriminator 30 to repeatedly perform learning (No in step S16: learning control step). Steps S14 and S16 are referred to as a learning control step.

In step S10, the processing (1) and (2) are performed for each dense unit included in the neural network.

(1) First, skip connections are selected with a predetermined probability (for example, a probability of 20%).

(2) Next, in a case where there is skip connections selected in (1), one skip connection to be invalidated is selected from the selected skip connections. In (2), the skip connection with a large number of skipped layers or the skip connection with a small number of skipped layers may be preferentially selected. That is, the skip connection with a large number of skipped layers or the skip connection with a small number of skipped layers may have a higher probability of being selected as an invalidation target. For example, considering that the deeper the layer, the easier the gradient disappearance occurs, the deeper layer may have a lower probability that a skip connection with a large number of skipped layers will be selected as an invalidation target, and the skip connection having a large number of skipped layers may be left at the time of learning. The skip connection to be invalidated may be selected randomly with the same probability.

Through these processing, 0 or 1 skip connection to be invalidated is selected in each dense unit.

In the embodiment, at the time of each learning, at least one skip connection is invalidated. For one of the repeated learnings, the learning may be performed without invalidating the skip connection.

The skip connection invalidation processing in step S12 is performed by (A) and (B).

(A) In a case where forward propagation for calculating a loss is performed, all values of data propagating through the skip connection to be invalidated are connected as 0.

(B) At the time of error backward propagation, no error propagates to the skip connection to be invalidated, or the gradient 0 propagates. As a result, propagation of data via the skip connection selected as the invalidation target is blocked, and the skip connection is invalidated.

In step S16, the learning of the discriminator 30 is repeatedly performed by changing the invalidation pattern of the skip connection. Then, in a case where learning is completed for all the predetermined invalidation patterns (Yes in step S16), the discriminator 30 including a learned neural network in which all of the neural networks of the discriminator 30 are validated can be obtained. In the learning method according to the embodiment, all the skip connections may be invalidated at least once, or skip connections that are not invalidated may occur.

According to the embodiment, by changing the skip connection to be invalidated and performing learning, it is possible to repeatedly perform learning using a neural network in which the layers are connected in a different manner. Therefore, ensemble learning can be realized, so that the generalization performance of the neural network can be improved. In the embodiment, the main stream connection is maintained by setting only the skip connection as the invalidation target. Therefore, it possible to suppress deterioration of the convergence performance of learning.

### Example 1: Application Example to Image Classification

Hereinafter, an example in which the discriminator 30 of the embodiment is applied to an image recognition engine will be described.

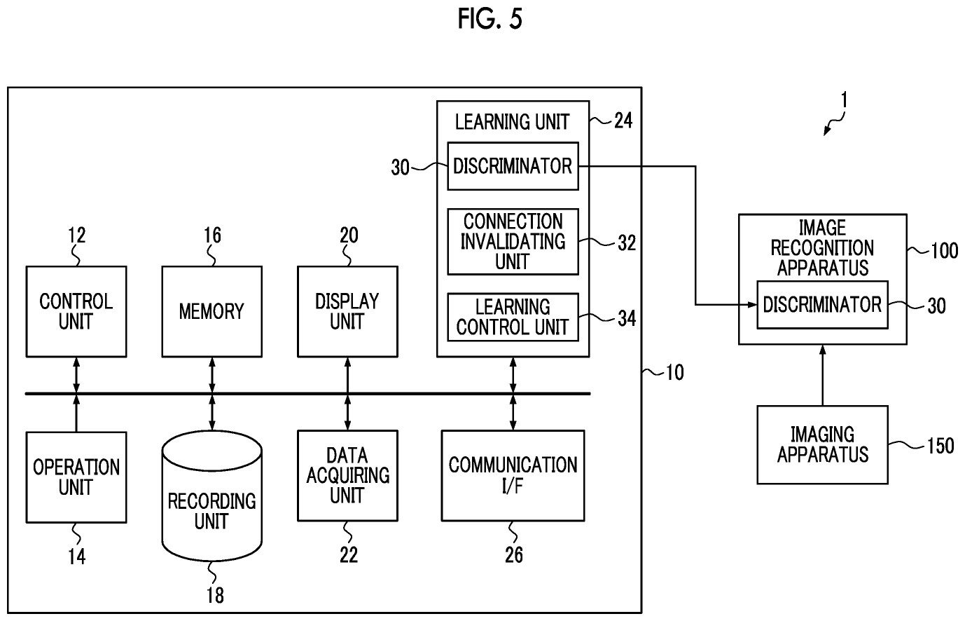

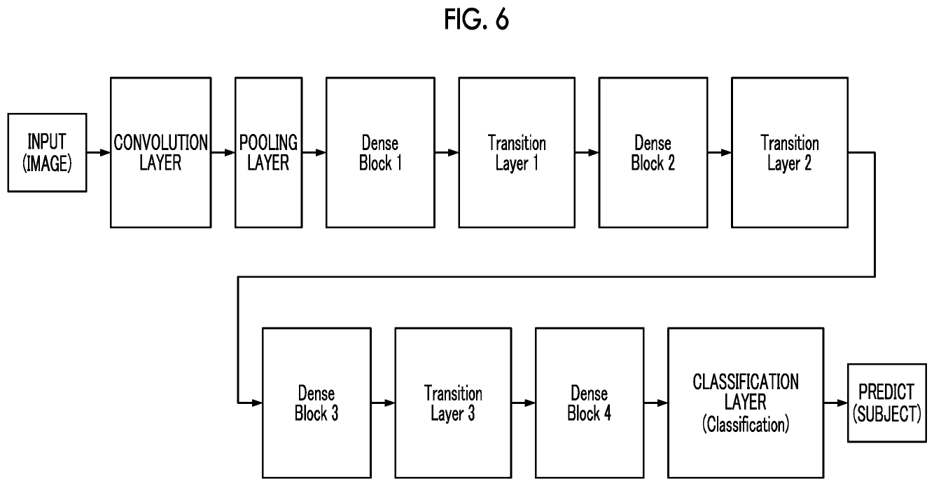

FIG. 5 is a block diagram showing an image recognition system comprising the learning apparatus according to the embodiment of the invention. FIG. 6 is a block diagram showing a configuration example of a neural network in a discriminator used in Example 1.

As shown in FIG. 5, an image recognition system 1 according to the embodiment includes an image recognition apparatus 100 and an imaging apparatus 150.

The imaging apparatus 150 is an apparatus that images a subject, and images a still image or a moving image. Image data imaged by the imaging apparatus 150 is input to the image recognition apparatus 100.

The image recognition apparatus 100 is an apparatus that recognizes a subject appearing in an image using the discriminator 30 that is the image recognition engine on which learning is performed in the learning apparatus 10. Then, the image recognition apparatus 100 classifies the image based on the recognized subject.

The discriminator 30 of the image recognition apparatus 100 can be updated by being replaced with the latest discriminator 30 that is learned by the learning apparatus 10.

In Example 1, an image is classified using a data set (for example, ImageNet) related to image classification with reference to a subject appearing in the image. In Example 1, the learning of the discriminator 30 is performed using a learning data set in which the image data is an input and the subject expressed by 1-of-K expression is an output (a correct answer label). The 1-of-K expression is a vector-type expression in which only one element is 1 and the others are 0, and is sometimes called a one-hot expression.

As shown in FIG. 6, the neural network according to Example 1 has a structure in which four dense blocks are connected by three transition layers. After the output from dense block 4 is input to the classification layer, a prediction indicating the name or type of the subject is output from the classification layer.

In Example 1, by performing a learning method similar to that of the above embodiment for each dense block of the neural network shown in FIG. 6, it is possible to create an image recognition engine for classifying 1000 classes of images with high generalization performance while suppressing deterioration of convergence performance.

### Example 2: Application Example to Lesion Segmentation

In Example 2, the learning method according to the embodiment is applied to lesion segmentation of a moving image imaged by an endoscope. In Example 2, the imaging apparatus 150 is provided in the endoscope.

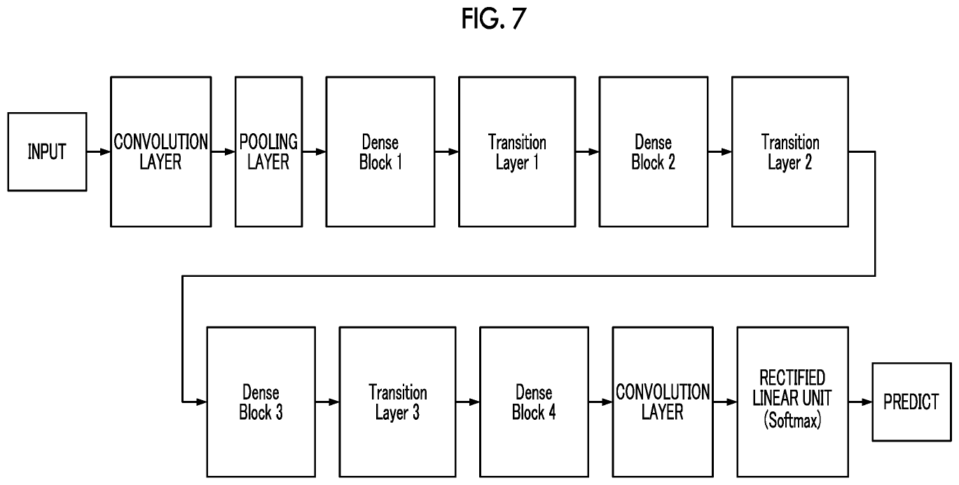

FIG. 7 is a block diagram showing a configuration example of a neural network in a discriminator used in Example 2.

As shown in FIG. 7, the neural network according to Example 2 has a structure in which four dense blocks are connected by three transition layers, as in FIG. 6. Then, the output from dense block 4 sequentially propagates to the convolution layer and the rectified linear unit (softmax function), and the prediction is output.

In Example 2, first, a frame included in moving image data imaged by the endoscope is extracted as still image data, and is input to a neural network. In Example 1, learning of the discriminator 30 is performed using a learning data set in which the input is still image data, which is a frame of a moving image imaged by the endoscope, and one of the outputs is a score map representing a probability that a lesion exists in the input still image data, and the other of the outputs is a score map representing a probability that no lesion exists in the input still image data. As the probability that a lesion exists in the input still image data, for example, it is possible to use a numerical value which is in the range of zero to 1 and in which a value closer to 1 has the higher the probability of existence of the lesion. As the probability that no lesion exists in the input still image data, for example, it is possible to use a numerical value which is in the range of zero to 1 and in which a value closer to 1 has the lower the probability of existence of the lesion.

In Example 2, by performing a learning method similar to the above embodiment for each dense block of the neural network shown in FIG. 7, it is possible to create an image recognition engine for the lesion segmentation with high generalization performance while suppressing deterioration of convergence performance.

### Example 3

In Example 3, the learning method according to the embodiment is applied to image recognition for a three-dimensional image (for example, a medical image). In Example 3, the imaging apparatus 150 is provided in, for example, an apparatus for imaging three-dimensional image data. The three-dimensional image includes cross-sectional image data of a subject imaged by an apparatus such as computed tomography (CT) or magnetic resonance imaging (MRI), and includes a group of image data in a direction perpendicular to the cross-section.

Also in Example 3, it is possible to use a neural network having a skip connection as shown in FIG. 3, FIG. 6, or FIG. 7.

For example, in a case where image data is classified based on a subject (for example, a lesion) included in the three-dimensional image data, learning of the discriminator 30 is performed using the learning data set in which the input is a three-dimensional CT image and the output is the presence or absence of a lesion or the type of a lesion.

In a case where segmentation is performed, learning of discriminator 30 is performed using a learning data set in which a three-dimensional CT image as an input, and a score map representing a probability that a subject included in the CT image is a specific organ (for example, a lung region) is an output.

Therefore, by performing a learning method similar to the above embodiment for the three-dimensional image data, it is possible to create an image recognition engine with high generalization performance while suppressing deterioration of convergence performance.

In the embodiment, image recognition in two-dimensional and three-dimensional image data is described, but the invention is not limited thereto, and the convolutional neural network can be adopted for convolution of N-dimensional (N is a natural number) data having a skip connection.

In the embodiment, an example in which the discriminator 30 is applied to image recognition is described, but the invention is not limited thereto. For example, the invention can be applied to a speech recognition engine.

[About Invention of Program]

The invention can also be realized as a program (a learning program) causing a computer to realize the above processing, or a non-transitory recording medium or a program product storing such a program. By applying such a program to a computer, it is possible for arithmetic means, recording means, and the like of the computer to realize a function corresponding to each step of the learning method according to the embodiment.

In each embodiment, the hardware structure of a processing unit that executes various types of processing can be realized as various types of processors described below. The various processors include the above-described CPU, which is a general-purpose processor that executes software (program) and functions as various processing units, a programmable logic device (PLD) that is a processor whose circuit configuration can be changed after manufacture, such as a graphics processing unit (GPU) or a field programmable gate array (FPGA), and a dedicated electric circuit that is a processor having a circuit configuration that is designed for exclusive use in order to execute specific processing, such as an application specific integrated circuit (ASIC).

One processing unit may be configured by one of these various processors, or two or more processors of the same type or different types (for example, a plurality of FPGAs, a combination of a CPU and a GPU, or a combination of a CPU and an FPGA). A plurality of processing units may be configured by one processor. As an example of configuring a plurality of processing units with one processor, first, as represented by a computer such as a client or a server, there is a form in which one processor is configured by a combination of one or more CPUs and software, and the processor functions as a plurality of processing units. Second, as represented by a system on chip (SoC), there is a form in which a processor is used that realizes the functions of the entire system including a plurality of processing units with a single integrated circuit (IC) chip. As described above, the various processing units are configured by one or more of the above various processors as a hardware structure.

The hardware structure of these various processors is more specifically an electric circuitry in which circuit elements such as semiconductor elements are combined.

### Explanation of References

10: learning apparatus
12: control unit
14: operation unit
16: memory
18: recording unit
20: display unit
22: data acquiring unit
24: learning unit
26: communication I/F
30: discriminator
32: connection invalidating unit
34: learning control unit
1: image recognition system
100: image recognition apparatus
150: imaging apparatus
S10 to S16: each step of learning method

What is claimed is:

1. A learning apparatus comprising:
a processor configured to
perform learning of a neural network composed of a plurality of layers and including a plurality of skip connections that branches an output from a first layer to a second layer which is a layer next to the first layer, and that skips the second layer and connects to an input of a third layer located downstream of the second layer;
invalidate at least one of the skip connections in a case where the learning is performed; and
change the skip connection to be invalidated by the connection invalidating unit and causes the learning unit to perform the learning.

2. The learning apparatus according to claim 1, wherein in the neural network, the skip connection is provided in an intermediate layer.

3. The learning apparatus according to claim 1, wherein the processor randomly selects the skip connection to be invalidated.

4. The learning apparatus according to claim 2, wherein the processor randomly selects the skip connection to be invalidated.

5. The learning apparatus according to claim 1, wherein the processor selects the skip connection to be invalidated based on a preset probability.

6. The learning apparatus according to claim 2, wherein the processor selects the skip connection to be invalidated based on a preset probability.

7. The learning apparatus according to claim 3, wherein the processor selects the skip connection to be invalidated based on a preset probability.

8. The learning apparatus according to claim 1, wherein the processor sets an output that forward propagates through the skip connection to zero to invalidate the skip connection.

9. The learning apparatus according to claim 2, wherein the processor sets an output that forward propagates through the skip connection to zero to invalidate the skip connection.

10. The learning apparatus according to claim 3, wherein the processor sets an output that forward propagates through the skip connection to zero to invalidate the skip connection.

11. The learning apparatus according to claim 4, wherein the processor sets an output that forward propagates through the skip connection to zero to invalidate the skip connection.

12. The learning apparatus according to claim 1, wherein the processor blocks backward propagation through the skip connection to invalidate the skip connection.

13. The learning apparatus according to claim 2, wherein the processor blocks backward propagation through the skip connection to invalidate the skip connection.

14. The learning apparatus according to claim 3, wherein the processor blocks backward propagation through the skip connection to invalidate the skip connection.

15. The learning apparatus according to claim 4, wherein the processor blocks backward propagation through the skip connection to invalidate the skip connection.

16. The learning apparatus according to claim 5, wherein the processor blocks backward propagation through the skip connection to invalidate the skip connection.

17. A learning method comprising:
a connection invalidating step of invalidating at least one of a skip connections, in a case where learning is performed by a processor that performs learning of a neural network composed of a plurality of layers and including a plurality of the skip connections that branches an output from a first layer to a second layer which is a layer next to the first layer, and that skips the second layer and connects to an input of a third layer located downstream of the second layer; and
a learning control step of changing the skip connection to be invalidated in the connection invalidating step and causing the processor to perform the learning.

18. A non-transitory computer readable recording medium storing a learning program causing a computer to realize:
a function of performing learning of a neural network composed of a plurality of layers and including a plurality of skip connections that branches an output from a first layer to a second layer which is a layer next to the first layer and that skips the second layer and connects to an input of a third layer located downstream of the second layer;
a function of invalidating at least one of the skip connections in a case where the learning is performed; and
a function of changing the skip connection to be invalidated and performing the learning.
